(19) United States
(12) Patent Application Publication
(10) Pub. No.: US 2015/0343384 A1
(43) Pub. Date: Dec. 3, 2015

(54) Reverse Osmosis Unit Having Rotatable Reverse Osmosis Membrane Housing Assembly

(71) Applicants: Douglas Kraig Shambough, Carencro, LA (US); Douglas Kirk Schambough, Carencro, LA (US); Jason Michael Badeaux, Gueydan, LA (US)

(72) Inventors: Douglas Kraig Shambough, Carencro, LA (US); Douglas Kirk Schambough, Carencro, LA (US); Jason Michael Badeaux, Gueydan, LA (US)

(21) Appl. No.: 14/723,129

(22) Filed: May 27, 2015

Related U.S. Application Data
(60) Provisional application No. 62/003,596, filed on May 28, 2014.

(51) Int. Cl. B01D 61/08; B01D 61/10; C02F 1/44

(52) U.S. Cl. CPC B01D 61/08; C02F 1/441; B01D 61/10; B01D 2313/54; B01D 2313/56; C02F 2103/08

(57) ABSTRACT

A reverse osmosis (“RO”) water purification unit has reverse osmosis membrane housings which are rotatably mounted, and movable between a first operating position in which the membrane housings are substantially vertically oriented, and a second service position in which the membrane housings are substantially horizontally oriented.

### CROSS REFERENCE TO RELATED APPLICATIONS

This non-provisional patent application claims priority to U.S. provisional patent application Ser. No. 62/003596, filed 28 May 2014, for all purposes.

### BACKGROUND

### Field of the Invention

This invention relates to apparatus used in the purification, especially desalinization, of water.

A supply of fresh water is required for many industrial purposes. By way of example only, fresh water is needed on offshore facilities used in the oil and gas industry, for example offshore production platforms and drilling rigs, for many purposes. Fresh water is needed for human consumption, washing, bathing, etc., but is also needed for a number of uses in connection with the operation of the facility, for example makeup and/or additions to drilling fluids, washdown water, etc. Suffice to say that an adequate supply of fresh water is an ever present need on offshore facilities.

Traditionally, fresh water had to be brought to offshore facilities in large tanks in the holds of vessels. Once the vessel was at the offshore location, the fresh water was pumped from the tank in the vessel to the offshore facility. The time, expense, and logistical difficulties associated with this procedure are well known in the industry. As a result, a need has long existed to generate fresh water from the readily available water surrounding the facility, which in offshore environments is sea water (salt water), but in inland lakes and the like might be brackish or even fresh water, but which is not of a sufficient purity for use on the facility, particularly for human consumption.

Particularly addressing the desalinization of salt water, a number of types of “water makers” have long existed. As is known in the relevant art field, such devices have employed a number of principles, e.g. evaporation. One type of desalinization unit which has been in use is a reverse osmosis or “RO” unit. Generally, a reverse osmosis unit forces salt water through a porous membrane which permits water to flow through, but prevents salt from flowing through. Reverse osmosis units generally are capable of satisfactory water production rates.

However, known reverse osmosis unit designs have certain limitations for use in offshore environments, in which space is at a premium on offshore facilities such as production platforms and drilling rigs. In particular, the reverse osmosis membranes are of an elongated shape and are situated inside of elongated membrane housings. Such housings may be on the order of 6 feet long. In order to change out these membranes as is periodically required, the membrane housings must be horizontally oriented. The membrane housings in prior art RO units are fixed in a horizontally oriented position; while such horizontal positioning eases change out of the membranes, at the same time it results in the RO units having a larger width dimension and therefore taking up a significant amount of space, or “footprint,” which is always at a premium on offshore structures. In particular, the length of the membrane housings generally dictates the width of the overall unit.

### SUMMARY OF THE INVENTION

The reverse osmosis unit embodying the principles of the present invention comprises one or more membrane housings, mounted within a frame or skid. An aspect of the present invention is that the membrane housings are mounted such that they can be rotated between a first operating position, in which the housings are generally vertically oriented while the unit is in operation (and producing desalinated water); and a second service position, in which the housings are generally horizontally oriented, when the unit is out of operation and to ease changing the RO membranes. Once the RO membranes are changed, the membrane housings are rotated back to their vertically oriented position. As can be readily understood, when the membrane housings are in the first vertically oriented operating position, the RO unit occupies a much reduced overall “footprint” or space requirement for the unit; yet when membrane replacement is required, the membrane housings can be rotated to the generally horizontal position for easy servicing. In a preferred embodiment, the membrane housings have a length dimension greater than the width of the RO unit frame.

In addition, the reverse osmosis unit of the present invention comprises pumps, controls, etc. as known in the art for operation of such units.

### BRIEF DESCRIPTION OF THE DRAWINGS

FIG. 1 is a perspective view of one embodiment of a reverse osmosis unit embodying the principles of the present invention, omitting certain of the elements for clarity.

FIG. 2 is a simplified front view of an embodiment of a reverse osmosis unit embodying the principles of the present invention, omitting certain of the elements for clarity in order to show the position of the reverse osmosis membrane housings in their first, vertically oriented operating position.

FIG. 3 is a simplified front view corresponding to FIG. 2, but showing the reverse osmosis membrane housings in their second, horizontally oriented service position.

FIGS. 4 and 5 show the rotatable reverse osmosis membrane housing mounting plate, with the reverse osmosis membrane housings in their vertical and horizontal positions, respectively. The membrane housings are shown in phantom lines.

FIG. 6 is a side view of the frame and skid of the unit, showing the membrane housing mounting plate positioned within the frame and skid.

### DESCRIPTION OF THE PRESENTLY PREFERRED EMBODIMENT(S)

While various reverse osmosis units can embody the principles of the present invention, with reference to the drawings some of the presently preferred embodiments can be described.

FIG. 1 is a perspective view of a reverse osmosis unit 10 embodying the principles of the present invention. Generally, the various operating components are held in a frame and skid, referred to hereafter as frame 20, which provides a secure mounting for the components and permits the entire unit to be moved by forklift, lifted by a crane as is frequently required in offshore settings, etc. As noted in FIG. 2, frame 20 has a width dimension W.

Typical components of reverse osmosis or RO units are well known in the art, and typically include one or more pumps 40, one or more electric motors 42 driving said pumps, and an electrical control panel 50. It is understood that electrical control panel 50 comprises various controls for operation of pumps 40 and other components of the RO unit. These components are shown in simplified form in the drawings. RO units also typically comprise a cartridge filter (not shown), through which seawater is first pumped in order to filter out particulate matter. From the cartridge filter, the filtered seawater flows to one or more reverse osmosis membranes, held within reverse osmosis membrane housings 60. It is understood that certain of the RO unit components are omitted from the drawings for clarity, such components not being essential to an understanding of the present invention.

Prior art RO units held the reverse osmosis membrane housings in a fixed, horizontally oriented position. Generally, the housings must be horizontally disposed in order to enable changing of the membranes therein. However, the horizontal placement of the relatively long (c. 6′) housings requires a relatively large footprint for the RO unit (i.e., a relatively large width or depth); a problem since space is always at a premium on offshore facilities.

In contrast, membrane housings 60 in the RO unit of the present invention are movable between a first, substantially vertically oriented operating position for normal operation, and a second, substantially horizontally oriented service position to allow changeout of the membranes therein. FIGS. 1 and 2 show the RO unit with membrane housings 60 in their first, vertically oriented operating position. FIG. 3 shows the RO unit with membrane housings 60 in their second, horizontally oriented service position.

FIGS. 2 and 3 are simplified views of the RO unit 10, with most components other than the membrane housings, mounting plate, and frame omitted for clarity. Membrane housings 60 are mounted on a rotatable mounting base 70, which is mounted on frame 20 so as to be rotatable, by a pivot point (described later herein). FIG. 2 shows membrane housings 60 in their substantially vertically oriented first operating position, which is the usual position during operation of the unit. FIG. 3 shows membrane housings 60 rotated to a substantially horizontally oriented second service position, to ease changeout of the membranes. As can be seen in FIG. 3, in a preferred embodiment, the relative dimensions of the width W of frame 20 and the length L of membrane housings 60 are such that membrane housings 60 extend beyond the horizontal dimensions or width of frame 20. As can be readily understood, the rotatable aspect of the present invention permits use of membranes/membrane housings which are longer than the horizontal width dimension of frame 20, thus increasing capacity and efficiency of the RO unit; yet when membrane housings 60 are rotated to their vertically oriented operating position, the unit occupies a small footprint.

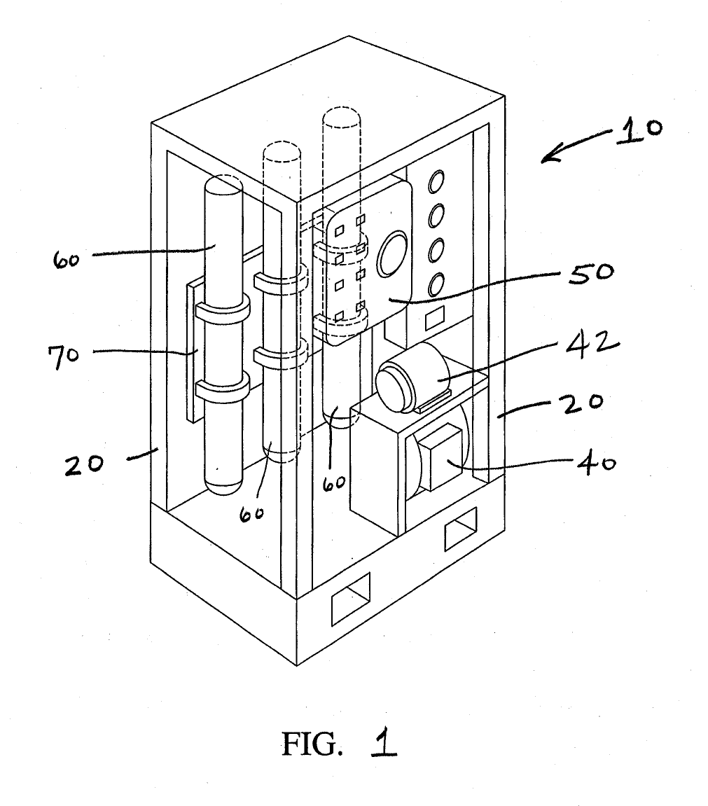

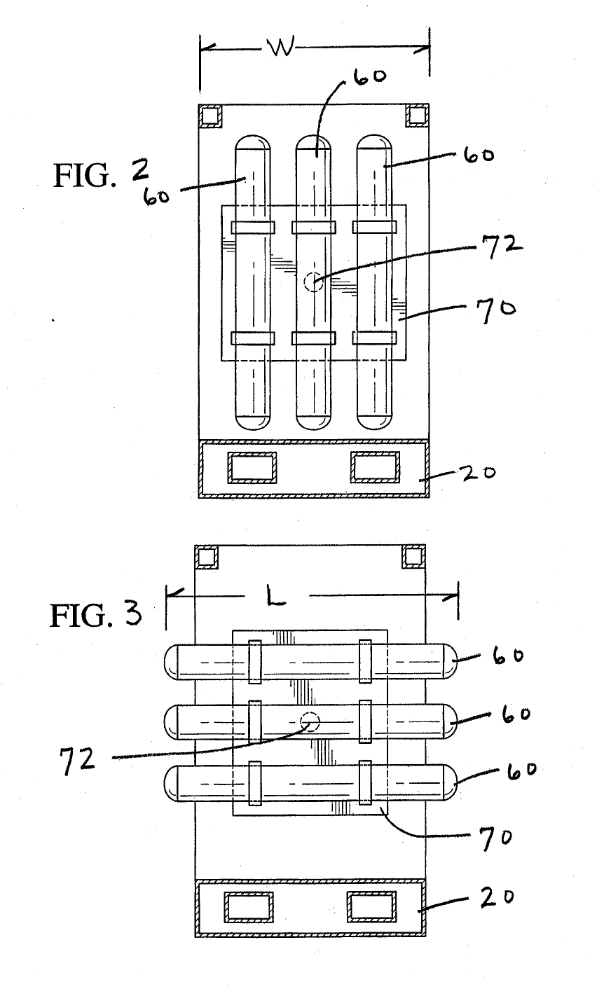

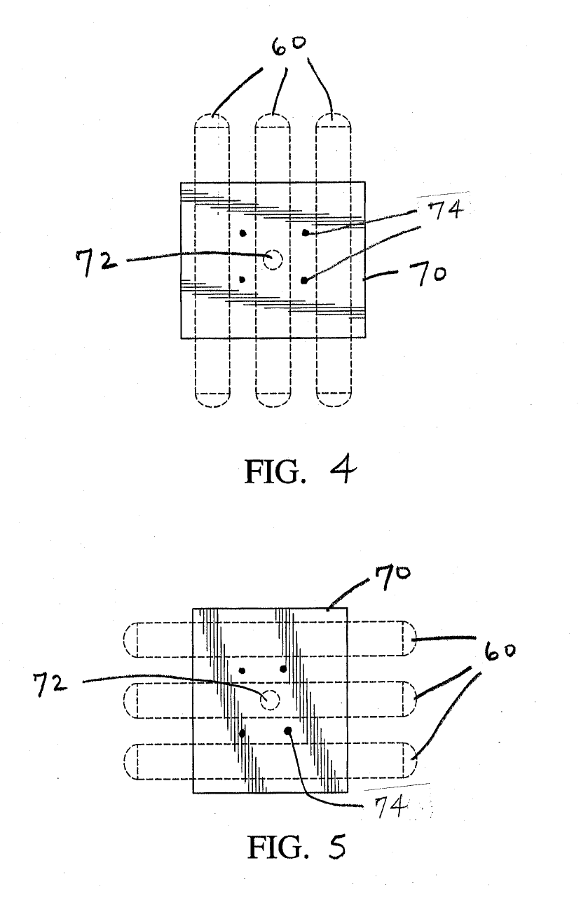

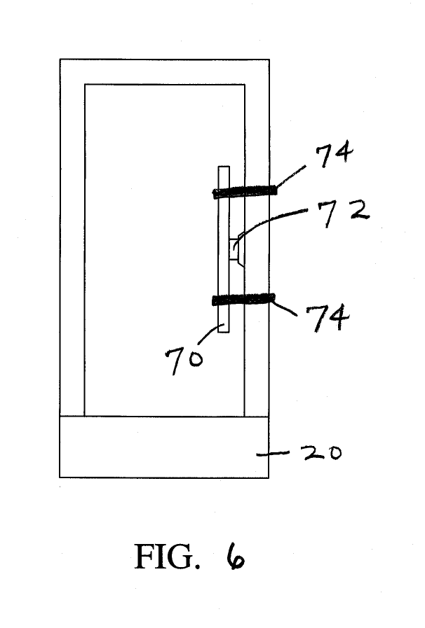

FIGS. 4 and 5 show further detail of mounting plate 70, with membrane housings 60 mounted thereon; for clarity, membrane housings 60 are shown in phantom lines. Mounting plate 70 is shown as a square or rectangle, but other shapes such as circular, etc. may be suitable as sell. Mounting plate 70 is rotatably mounted on a pivot point 72, which may be a simple bolt or pin fixed to frame 20, on which mounting plate 70 may rotate. FIG. 6 is a side view of frame 20 and mounting plate 70, showing the position of pivot point 72. In order to hold mounting plate 70 and membrane housings 60 fixed in the desired position, whether vertically or horizontally oriented, one or more fasteners 74 rotationally fix mounting plate 70 to frame 20. Fasteners 74 may comprise pins, bolts, etc. inserted through mounting plate 70 and into some part of frame 20. While four fasteners 74 are shown, a greater or lesser number of fasteners may be used. It is understood that other means of locking mounting plate 70 in a desired position and preventing it from rotating, when desired, may be used, such as locking collars, stop blocks, etc.

Operation of RO unit 10 may be readily understood. To change the RO membranes, the unit is shut down, depressurized, etc. Fasteners 74 are removed, and mounting plate 70 with membrane housings 60 thereon is rotated to the position shown in FIG. 3, with membrane housings 60 in their second service position (the horizontal position). At least one of fasteners 74 is preferably then re-installed to hold the assembly with membrane housings 60 in the horizontal position while the membranes are being changed. Once that is done, the fastener is removed, the mounting plate and membrane housing assembly rotated back to the position shown in FIGS. 1 and 2, with the membrane housings 60 in their first operating position (vertical position), and one or more of fasteners 74 re-installed to lock the assembly in the vertical position.

### Conclusion

While the preceding description contains many specificities, it is to be understood that same are presented only to describe some of the presently preferred embodiments of the invention, and not by way of limitation. Changes can be made to various aspects of the invention, without departing from the scope thereof. For example, dimensions of the unit can be changed to suit particular settings; the size and shape of mounting plate may be varied; the means to rotationally lock mounting plate with respect to frame 20 may be varied; the number of membrane housings may be varied; capacity of the units may be changed to meet particular needs, etc.

Therefore, the scope of the invention is to be determined not by the illustrative examples set forth above, but by the appended claims and their legal equivalents.

We claim:

1. A reverse osmosis water purification unit, comprising:
one or more elongated reverse osmosis membrane housings having a length;
a pump fluidly connected to said membrane housings, for pumping water through said membrane housings and reverse osmosis membranes therein;
wherein said reverse osmosis membrane housings are rotatably mounted on said unit and rotatable between a first, substantially vertically oriented operating position, and a second, substantially horizontally oriented service position.

2. The reverse osmosis unit of claim 1, wherein said reverse osmosis unit comprises a frame having a width, and said length of said membrane housings is greater than said width of said frame.

3. The reverse osmosis unit of claim 2, further comprising one or more fasteners which lock said membrane housings in either said first operating position or said second service position.

4. The reverse osmosis unit of claim 3, wherein said membrane housings are mounted on a plate which is in turn mounted on said frame by a pivot point.

5. The reverse osmosis unit of claim 1, further comprising one or more fasteners which lock said membrane housings in either said first operating position or said second service position.

6. The reverse osmosis unit of claim 1, further comprising an electric motor driving said pump and an electrical control panel operatively connected to said motor.

7. A compact reverse osmosis unit for the purification of water, comprising:
a frame adapted to be moved by a forklift or crane, said frame having a width;
one or more elongated reverse osmosis membrane housings having a length, rotatably mounted on said frame, and rotatable between a first, substantially vertically oriented operating position, and a second, substantially horizontally oriented service position;
a pump mounted on said frame and fluidly connected to said membrane housings, for pumping water through said membrane housings and reverse osmosis membranes therein, said pump driven by an electric motor;
controls and an electrical control panel operatively connected to said pump, for controlling the pumping of water through said membrane housings.

8. The reverse osmosis unit of claim 7, further comprising one or more fasteners which lock said membrane housings in either said first operating position or said second service position.

9. The reverse osmosis unit of claim 8, wherein said membrane housings have a length greater than said width of said frame.

10. The reverse osmosis unit of claim 9, wherein said membrane housings are disposed on a mounting plate rotatably connected to said frame.
